(19) United States
(12) Patent Application Publication
(10) Pub. No.: US 2007/0083908 A1
(43) Pub. Date: Apr. 12, 2007

(54) System and method of providing web-related content

(75) Inventors: Mary McCarthy, San Antonio, TX (US); Tony Haeuser, Aurora, IL (US); Scott Pettit, San Antonio, TX (US); Chris Lee, San Antonio, TX (US); Ross Cox, Kyle, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/248,592

(22) Filed: Oct. 12, 2005

(51) Int. Cl. H04N 7/173

(52) U.S. Cl. 725/112; 725/110; 725/113

(57) ABSTRACT

The present disclosure is directed to a system and method of providing web-based content. The method can include receiving at least one user preference via a user account of a public data network, where the at least one user preference indicates at least one type of content available via the public data network. The method can also include generating a user interface, where the user interface includes the type of content indicated by the at least one user preference. The method can also include associating the user account with a set-top box device and transmitting the user interface to the set-top box device via an Internet Protocol Television (IPTV) system.

### FIELD OF THE DISCLOSURE

The present disclosure relates generally to providing web-based content.

### BACKGROUND

Television viewing is a popular form of entertainment. Developments in television and digital video technologies allow viewers to watch a wide variety of high-resolution content and to record programs for later viewing. Recent advancements, such as video-on-demand and the expansion of available channels, have added to the breadth and convenience of television programming. Viewers have considerable freedom to determine and schedule the types of programming content that they watch.

While television programming provides a variety of information and content, it is largely bound by program scheduling. The Internet offers users an alternative source for many types of information, such as weather, financial information, etc. Moreover, users can access any type of web-based content at any time. Nonetheless, users must often interrupt their television viewing in order to access the Internet via a computing device. Additionally, accessing a preferred type of web-based content regularly can require users to spend time repeating navigation steps.

### BRIEF DESCRIPTION OF THE DRAWINGS

FIG. 1 is a block diagram illustrating an embodiment of an Internet Protocol Television (IPTV) system;

FIG. 2 is a flow diagram illustrating a method of providing web-based content over an IPTV system;

FIG. 3 is a flow diagram illustrating a method of receiving web-based content over an IPTV system;

FIG. 4 is a diagram of an embodiment of a graphical user interface to receive web-based content;

FIG. 5 is a diagram of a second embodiment of a graphical user interface embodiment to receive web-based content; and

FIG. 6 is a diagram of an embodiment of a general computer system.

### DETAILED DESCRIPTION OF THE DRAWINGS

A system to receive web-based content is disclosed. The system can include a set-top box device comprising a processor and a memory accessible to the processor. The system can also include a computer program embedded within the memory and executable by the processor, the computer program comprising instructions to receive a user interface at the set-top box device via a private network within an IPTV system, where the user interface includes at least one type of content available via a public network. The set-top box device can be associated with a public network user account at a server within the IPTV system, and the at least one type of content can be associated with a user preference received at the public network user account.

In another embodiment, a system to provide web-based content is disclosed. The system can include a set-top box device comprising a processor and a memory accessible to the processor. The system can also include a computer program embedded within the memory. The computer program can include instructions to receive data via a user account of a public data network, wherein the data includes a type of content available via the public data network. The computer program can also include instructions to associate the user account with a user interface that is selectively communicated to a set-top box device via the private data network. The computer program can also include instructions to modify the user interface to include the type of content, based at least partially on the data. The computer program can also include instructions to transmit the modified user interface to the set-top box device via the private data network.

In another embodiment, a method of providing web-based content is disclosed. The method can include receiving at least one user preference via a user account of a public data network, where the at least one user preference indicates at least one type of content available via the public data network. The method can also include generating a user interface, where the user interface includes the type of content indicated by the at least one user preference. The method can also include associating the user account with a set-top box device and transmitting the user interface to the set-top box device via an Internet Protocol Television (IPTV) system.

In another embodiment, a method of receiving web-based content is disclosed. The method can include receiving a user interface at a set-top box device via a private network within an IPTV system, where the user interface includes at least one type of content available via a public network. wherein the set-top box device is associated with a public network user account at a server within the IPTV system. The set-top box device can be associated with a public network user account at a server within the IPTV system, and the at least one type of content can be associated with a user preference received at the public network user account.

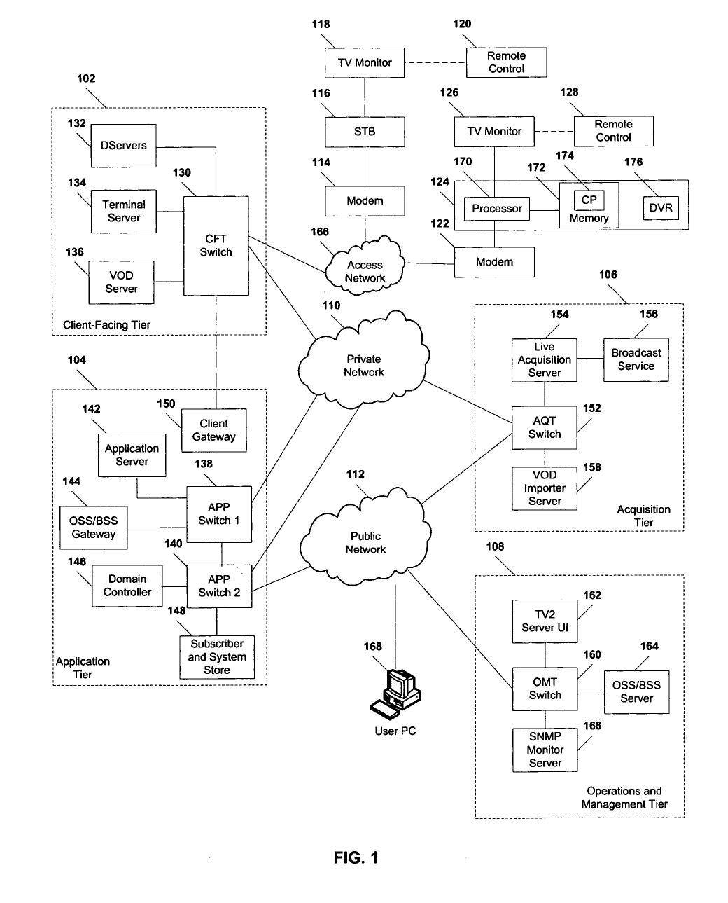

Referring to FIG. 1, an IPTV system is shown and is generally designated 100. As shown, the system 100 can include a client facing tier 102, an application tier 104, an acquisition tier 106, and an operations and management tier 108. Each tier 102, 104, 106, 108 is coupled to a private network 110, a public network 112, or both the private network 110 and the public network 112. For example, the client-facing tier 102 can be coupled to the private network 110. Further, the application tier 104 can be coupled to the private network 110 and to the public network 112, such as the Internet. The acquisition tier 106 can also be coupled to the private network 110 and to the public network 112. Moreover, the operations and management tier 108 can be coupled to the public network 112.

As shown in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

As illustrated in FIG. 1, the client-facing tier 102 can communicate with user equipment via a private access network 166, such as an Internet Protocol Television (IPTV) network. In an illustrative embodiment, modems, such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes, such as the representative set-top boxes 116, 124, over a wide geographic area, such as a regional area, a metropolitan area, a viewing area, or any other suitable geographic area that can be supported by networking the client-facing tier 102 to numerous set-top box devices.

In one embodiment, the client-facing tier 102 can be coupled to the modems 114, 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the private access network 166, via an IPTV software platform, such as Microsoft® TV IPTV Edition.

Additionally, the first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128.

In an exemplary, non-limiting embodiment, each set-top box device 116, 124 can receive data or video from the client-facing tier 102 via the private access network 166 and render or display the data or video at the display device 118, 126 to which it is coupled. In an illustrative embodiment, the set-top box devices 116, 124 can include tuners, such as the tuner 184 shown in FIG. 1, that receive and decode television programming information for transmission to the display devices 118, 126. Further, the set-top box devices 116, 124 can include a STB processor 178 and a STB memory device 180 that is accessible to the STB processor 178. In a particular embodiment, the set-top box devices 116, 124 can also communicate commands received from the remote control devices 120, 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server 168 and other devices with a common connection point to the private network 110. In a particular embodiment, the CFT switch 130 can also be coupled to a video-on-demand (VOD) server 136.

As shown in FIG. 1, the application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116, 124 via the private access network 166, so the set-top box devices 116, 124 can provide functions, such as display, messaging, processing of IPTV data and VOD material, etc. In a particular embodiment, the OSS/BSS gateway 144 includes operation systems and support (OSS) data, as well as billing systems and support (BSS) data.

Further, the second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116, 124 can access the system via the private access network 166, using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when a set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/JBSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, e.g., because it is connected to a different twisted pair, the client gateway 150 can deny transmissions to and from the set-top box device 116 beyond the private access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 166 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 can transmit the television content to the AQT switch 152, in turn, and the AQT switch 152 can transmit the television content to the CFT switch 130 via the private network 110. Further, the television content can be encoded at the D-servers 132, and the CFT switch 130 can communicate the television content to the modems 114, 122 via the private access network 166. The set-top box devices 116, 124 can receive the television content from the modems 114, 122, decode the television content, and transmit the content to the display devices 118, 126 according to commands from the remote control devices 120, 128.

Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When a user issues a request for VOD content to a set-top box device 116, 124, the request can be transmitted over the private access network 166 to the VOD server 136, via the CFT switch 130. Upon receiving such a request, the VOD server 136 can retrieve requested VOD content and transmit the content to the set-top box device 116,124 across the private access network 166, via the CFT switch 130.

In an illustrative embodiment, the live acquisition server 154 can transmit the television content to the AQT switch 152, and the AQT switch 152, in turn, can transmit the television content to the OMT switch 160 via the public network 112. In this embodiment, the OMT switch 160 can transmit the television content to the TV2 server 162 for display to users accessing the user interface at the TV2 server 162. For example, a user can access the TV2 server 162 using the computer 176 coupled to the public network 112.

As shown in FIG. 1, the domain controller 146 communicates with the public network 112 via the second APP switch 140. Additionally, the domain controller 146 can communicate via the public network 112 with one or more user personal computers (PCs) 168. For example, the domain controller 146 can display a web portal via the public network 112 and allow users to access the web portal using a PC 168.

For example, the user can use the PC 168 to access a web portal maintained by the domain controller 146, via the public network 112. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124, by associating the user account with an IP address of the second set-top box device 124, with data relating to one or more twisted pairs connected with the second set-top box device 124, with data relating to one or more fiber optic cables connected with the second set-top box device 124, with an alphanumeric identifier of the second set-top box device 124, with any other data that is suitable for associating second set-top box device 124 with a user account, or with any combination of these.

In a particular embodiment, after the domain controller 146 has authenticated and verified the user, the domain controller 146 can allow the user to access his or her public data network user account, such as an Internet account, via the PC 168. The user can enter preferences to the user account via the PC 168. Each preference indicates a type of content that the user prefers to view in conjunction with a web browser at the PC 168 and/or with a television display transmitted to a display device 118, 126 by a set-top box device 116, 124.

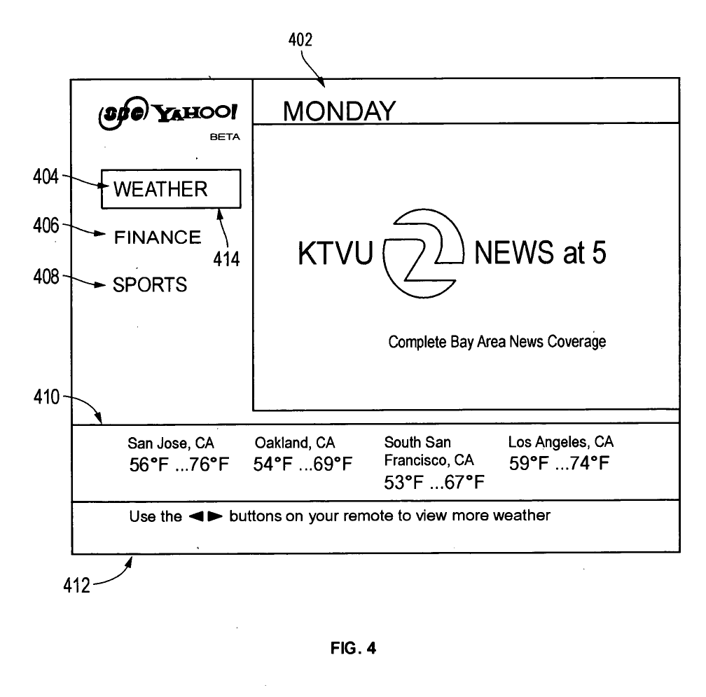

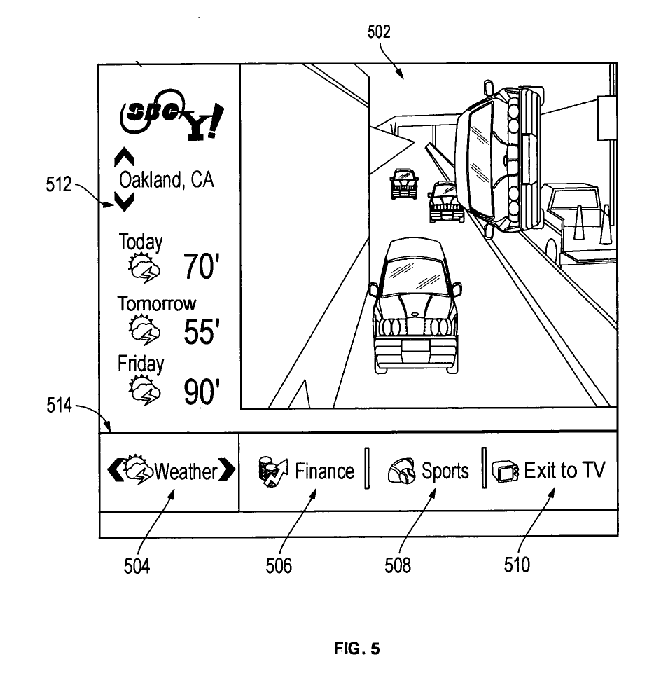

Upon receiving one or more user preferences from the user via the PC 168, the domain controller 146 can generate a user interface, or data associated with rendering a user interface, that incorporates the preferences received from the user. The user interface is described further with reference to FIGS. 4-5. The user interface or related data can be associated with the user's set-top box device 116, 124 and stored in conjunction with the user's Internet account. This information may be stored at the domain controller 146, at the subscribed and system store 148, or at any one or more components of the IPTV system 100 that are suitable for storing a user interface in conjunction with a set-top box identification and for communicating the user interface or related data to a web browser via the PC 168 and to a set-top box 116, 124 via the private access network 166.

In an exemplary, non-limiting embodiment, a user can request that the user interface associated with the user's set-top box device be displayed in conjunction with a web browser at the PC 168. The user interface, or data associated with the user interface, can be transmitted by the domain server 146 to the PC 168 via the public network 112. The PC 168 can display the user interface via its screen or monitor, or the PC 168 can generate and render the user interface from related data that it has received via its display. The user interface can overlay a portion of the web browser, or at least partially frame the web browser.

In another example embodiment, the user can request that the user interface be displayed in conjunction with television content at a display device 118, 126. The request can be received from the user's set-top box 116, 124 at the CFT switch 130 via the private access network 166. The request can be transmitted by the CFT switch 130 via the private network 112 to the device that stores the user interface, or data associated with the user interface, in conjunction with the user's account, such as the domain controller 146 or the subscriber and system store 148. The user interface or related data can be received at the CFT switch 130 and transmitted to the requesting set-top box device 116, 124 via the private access network 166. In a particular embodiment, the CFT switch 130 can also transmit television programming that it receives from the acquisition tier 106 along with the user interface.

As shown in FIG. 1, a set-top box device, such as the second set-top box device 124, can include a processor 170 and a memory device 172 that is accessible to the processor 170. The set-top box device 124 also includes a computer program 174 that is embedded within the memory device 172. In a particular embodiment, the computer program 174 can include instructions to receive a user interface that incorporates at least one content preference that a user has entered at a user account of a public network via the domain controller 146. In another embodiment, the computer program 174 can include instructions to receive data associated with the user interface and to generate and render the user interface at the display device 118, 126. The user interface can overlay a portion of the television programming, or at least partially frame the television programming, when the user interface is displayed at the display device 118, 126.

In an illustrative embodiment, the computer program 174 can include instructions to receive selections of web-based content at the set-top box device 124 via the user interface and to transmit web-based content to the display device 126. For instance, a user can make selections on the user interface by using a remote control 128 to communicate with the set-top box device 124. After the set-top box device 124 receives the user's selection, the set-top box device 124 can transmit the selection to the CFT switch 130 via the private access network 166. The CFT switch 130 can transmit the selections to the domain controller 146 via the private network 110, for example, and the domain controller 146 can retrieve the requested web-based content from the public network 112. The selected web-based content can be communicated back to the CFT switch 130 and to the set-top box device 124 via the private access network. The set-top box device 124 can receive the selected content and transmit it to the display device 126 for display to the user.

In an alternative embodiment, the set-top box device 124 can retrieve web-based content using a virtual private network (VPN) client software program that allows the web-based content to be delivered to the set-top box device 124, without traveling through the web to find the web-based content.

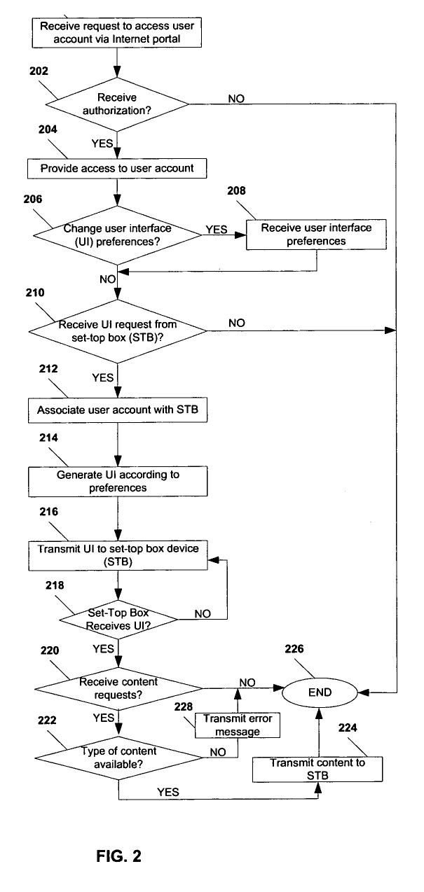

Referring to FIG. 2, a method of customizing a set-top box user interface with web-based content is illustrated. At block 200, a request to access a user account is received at a server via a web portal. In a particular embodiment, the request is received via a public network, e.g., the Internet. At decision step 202, it is determined whether authorization information that corresponds to the user account has been received. For example, it can be determined whether a user identification and password are received. If the correct authorization information is not received, the method terminates at 226. If the correct authorization information is received, the method proceeds to block 204 and access to the user account is provided.

In a particular embodiment, as shown at block 206, the user can be prompted with a selection to change preferences relating to a user interface that provides web-based content at a user television or web browser. If the server receives a selection not to change preferences relating to the user interface, the method proceeds to decision step 210. Conversely, if the server receives a selection to change preferences relating to the user interface, the method proceeds to block 208, and new preferences are received from the user at the server. The method then continues to decision step 210.

In a particular embodiment, preferences relating to the user interface can include types of content that the user prefers to access via the user interface. The types of content can include weather content, such as weather information, forecasts and radar for a user-defined geographic area and time period. Further, the types of content can include sports content for user-defined teams, events, and the like, as well as financial content, such as stock quotes, interest rates, currency exchange rates, etc. Also, the types of content can include news content and entertainment content, such as current films, celebrity news, and local entertainment events. The types of content can also include science content and health content. Additionally, the types of content can include travel content, e.g., travel specials, destination information and map content.

In addition to informational content, other examples of content that a user can select for the user interface include personalized information and interactive content. Personalized information can include addresses and phone numbers of user-defined contacts and calendar content, such as daily calendars, weekly calendars, monthly calendars, and yearly calendars, and appointments on specific dates. Interactive content can include music content, such as radio stations or music channels provided by an IPTV service. Interactive content can also include video games, chat room access, e-mail access, and Internet search engine access.

A user can select other content for the user interface, such as photograph content and video content that the user submits to the server via the user account. In one embodiment, photographs can be incorporated into a slide show that the user can access via the user interface. Another example of content includes real-time or near real-time information or video related to traffic along user-defined routes.

In addition to content preferences, other preferences relating to the user interface can also be received from a user. For instance, the display of the user interface can be manipulated such that it overlays other content, such as a web browser or television content. Alternatively, the user interface can be manipulated to appear as an L-bar or partial frame around the web browser or television content. Additionally, preferences regarding the selection and display of content can be received. Content, such as weather information, can be displayed, for example, within the user interface when it is displayed. Other content, such as financial information, can be made selectable through soft buttons or cursor manipulation.

Continuing to decision step 210, it can be determined at the server whether a request has been received from a set-top box device to receive a user interface. In a particular embodiment, the request can be received from the set-top box device via a private network within an IPTV system. If no request is received, the method terminates at state 226. On the other hand, if a request for a user interface is received at the server, the method moves to block 212 and the server associates the set-top box device with a user account. In one embodiment, the server can query an information store, e.g., the subscriber and system store 148 described with reference to FIG. 1, which associates various set-top box devices with corresponding user accounts. For instance, the information store can relate a user account to the set-top box device, by associating a user account with an IP address of the set-top box device, with data relating to one or more twisted pairs connected with the set-top box device, with data relating to one or more fiber optic cables connected with the set-top box device, with an alphanumeric identifier of the set-top box device, with any other data that is suitable for associating a set-top box device with a user account, or with any combination of these.

Proceeding to block 214, the server can generate the user interface according to the content types and other preferences received from the user via the user's Internet account. In a particular embodiment, the user interface can include the actual content requested by the user or one or more icons that represent the content desired by the user. A user can select an icon via the user interface and receive the associated content. At block 216, the server transmits the personalized user interface to the set-top box device that issued the request. Moving to decision step 218, the server can determine whether the set-top box device received the user interface. For example, an acknowledgement can be received from the set-top box device when the set-top box device receives the user interface. If the server determines that the user interface has not been received by the set-top box device, the server continues transmitting the user interface to the set-top box device at block 216. Once the user interface is received, the method proceeds to decision step 220.

Proceeding to decision step 220, the server can determine whether one or more requests for web-based content have been received from the set-top box device. In a particular embodiment, the user interface can include one or more icons that represent the content desired by the user. A user can select an icon via the user interface and a request can be transmitted by the set-top box device to the server, e.g., the domain controller 146 in FIG. 1. Requests can also be transmitted automatically by the server. In one embodiment, an automatic and/or periodic refresh request, similar to refresh requests issued via a web browser, can be received at the server from the set-top box device. If no requests for web-based content are received, the method terminates at state 226. Conversely, if one or more requests for web-based content are received, the method moves to decision step 222, and the server determines whether the requested content is available. If the server determines that the web-based content is not available, the method moves to block 228, and the server transmits an error message to the set-top box device for display at a display device. For example, the error message can indicate that the requested content is unavailable. Returning to decision step 222, if the server determines that the requested web-based content is available, the method moves to block 224, and the server transmits the web-based content to the set-top box device via the private network within the IPTV system, at block 224. The method terminates at state 226.

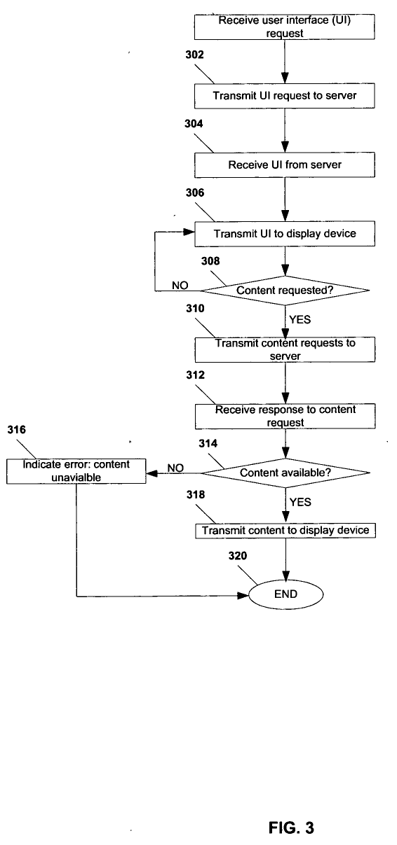

Referring to FIG. 3, a method of receiving web-based content is shown. At block 300, a set-top box device receives a request from a user for a user interface that is configured to receive web-based content. In a particular embodiment, the request is received from the user via a remote control device. Moving to block 302, the set-top box device transmits the request to a server via a private network within an IPTV system. The set-top box device receives the user interface from the server at block 304. Moving to block 306, the set-top box device transmits the user interface to a display device, e.g., a television monitor via the private network within an IPTV system. In a particular embodiment, the user interface can be transmitted with television content. In an illustrative embodiment, the user interface can overlay a portion of the television content. In another illustrative embodiment, the user interface can at least partially frame the television content.

Continuing to decision step 308, the set-top box device can determine whether one or more requests for web-based content have been received from the user. In one embodiment, a user can issue a request for web-based content to the set-top box device by using a remote control device to manipulate a cursor about the user interface and selecting soft buttons, hyperlinks, or icons that correspond to desired web-based content. If the user does not request content, the method can return to block 306 and the set-top box device can continue transmitting the user interface to the display device. On the other hand, if one or more requests for web-based content are received at the set-top box device, the method moves to block 310, and the set-top box device transmits the request(s) to the server.

As shown in FIG. 3, at block 312, the set-top box device can receive a response to the request(s) that it has transmitted to the server. Proceeding to decision step 314, the set-top box device can determine whether the response includes an indication that the requested web-based content is available. If the requested web-based content is available, the set-top box device can transmit the requested web-based content to the display device for display to the user, at block 318. The method then ends at state 320.

Alternatively, at decision step 314, if the requested web-based content is unavailable, the method continues to block 316 and the set-top box device can transmit an error message to the display device. For example, the error message indicates that the requested web-based content is not available. Such an error message can be generated by the set-top box device in response to a trigger from the server, or the error message can be received from the server at the set-top box device.

In an illustrative embodiment, informational web-based content, such as news, financial data, sports scores, weather, and the like can be incorporated with the user interface, such that it is displayed as a frame or overlay to television content. Personalized or interactive web-based content can be displayed in alternate fashions. For example, if a user requests that photographs or video content submitted to the server via an Internet user account, the photographs or video content can be displayed as a slide show or movie that the user can manipulate via the remote control device. Moreover, the set-top box device can transmit the photographs or video content to the display device via an auxiliary channel. In another example, if a user selects music content, the user can be prompted to decide whether radio content or preset music playlists are desired. The set-top box device can receive the user's selection and request such content from the server. After the set-top box device receives the content, it can transmit the music to the display device for broadcast, or the set-top box device can broadcast the music.

In a particular embodiment, a user can request interactive Internet based functions via the user interface. The user can access search engines, chat rooms, e-mail accounts, and other web based applications. A user's request for such functions are transmitted to the server by the set-top box device via a private network within an IPTV system. The server can transmit display screens that correspond to the Internet functions requested and transmit updated versions of the screens that correspond to user inputs that the set-top box device transmits to the server.

A user can also use the user interface to monitor traffic along routes that the user has designated via an Internet account. If a user transmits a request for traffic content to the set-top box device, the set-top box can transmit the request to the server and receive real-time or delayed traffic information that can be incorporated into the user interface. Moreover, the set-top box device can receive real-time or delayed traffic video for designated routes and transmit the video to a display device via an auxiliary channel.

Referring to FIG. 4, a user interface to receive web-based content is shown at 400. In an exemplary, non-limiting embodiment, the user interface 400 can partially frame a television content region 402 in which television programming is displayed. The user interface 400 can include soft buttons, e.g., a weather soft button 404, a finance soft button 406, and a sports soft button 408. In a particular embodiment, a user can use the soft buttons 404, 406, 408 to request associated types of web-based content via an IPTV system. For example, a user can move a highlight bar 414 along the soft buttons 404, 406, 408 using arrow keys on a remote control device. Further, the user can select a soft button by pressing an ‘Enter’ key when the appropriate soft button is highlighted.

As shown in FIG. 4, the user interface can also include a content display region 410, in which web-based content that is requested by a user selecting one of the soft buttons 404, 406, 408 is displayed. Additionally, certain types of content designated by the user can be displayed as a default in the content display region 410, when no other web-based content has been requested. The user interface can also include a command region 412 that indicates commands that the user may issue using a remote control. In a particular embodiment, the commands can be specific to the content displayed. In another particular embodiment, the commands can relate to general control of the user interface.

Referring to FIG. 5, a user interface to receive web-based content is shown at 500. In an exemplary, non-limiting embodiment, the user interface 500 can partially frame a television content region 502 in which video content designated by a user is displayed. The user interface 500 can include soft buttons, e.g., a weather soft button 504, a finance soft button 506, a sports soft button 508, and an exit to TV soft button 510. In a particular embodiment, a user can use the soft buttons 504, 506, 508 to request associated types of web-based content via an IPTV system or to close or exit from the user interface. For example, a user can move a highlight bar 514 along the soft buttons 504, 506, 508, 510 using arrow keys on a remote control device. Further, the user can select a soft button by pressing an ‘Enter’ key when the appropriate soft button is highlighted. When a type of web-based content is selected, related web-based content can be displayed in a content display region 512. Additionally, certain types of content designated by the user, such as weather content, can be displayed as a default in the content display region 512, when no other web-based content has been requested.

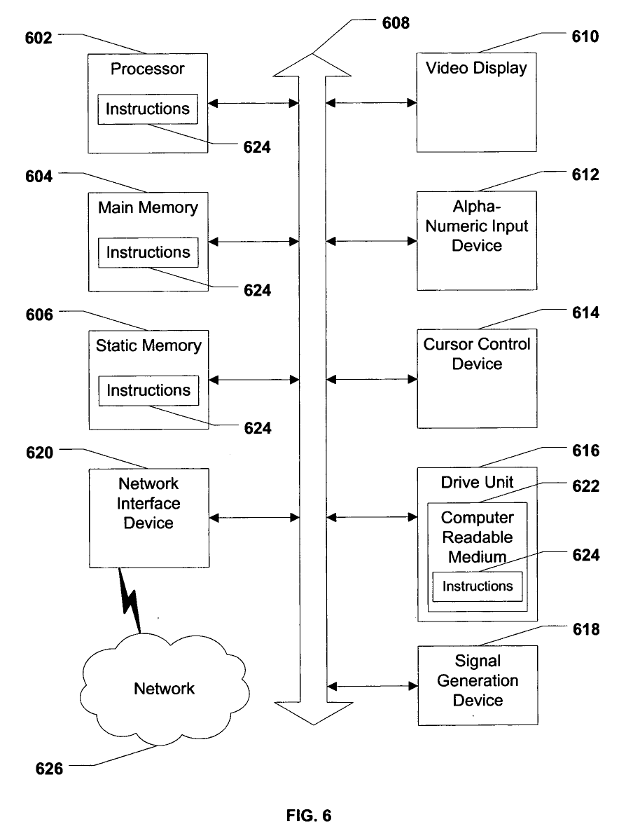

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600, or any portion thereof, may operate as a standalone device, such as the set-top box devices and domain controller shown in FIG. 1, or may be connected, e.g., using a public network or a private network within an IPTV system, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. Further, the computer system 600 can include a wireless input device 615, e.g., a remote control device. When the computer system 600, or any portion thereof, is embodied in a set-top box device, the cursor control device 614 can be a remote control device. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In conjunction with the configuration of structure described herein, the system and method disclosed provide web-based content in conjunction with television content via an IPTV network. The web-based content is selectable and can be displayed via an interactive user interface that is linked to a user's preferences. By associating user accounts with set-top box devices at the server level, preferences will be retrieved and recognized without the need for a user to log in to his or her television. Moreover, by attaching set-top box devices to Internet accounts, users can access personalized and interactive content, in addition to informational web-based content.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing web-based content, the method comprising:
receiving at least one user preference via a user account of a public data network, wherein the at least one user preference indicates at least one type of content available via the public data network;
generating a user interface, wherein the user interface includes the type of content indicated by the at least one user preference;
associating the user account with a set-top box device; and
transmitting the user interface to the set-top box device via an Internet Protocol Television (IPTV) system.

2. The method of claim 1, wherein the at least one user preference is received via the public data network.

3. The method of claim 1, wherein the user interface is transmitted via a private network within the IPTV system.

4. The method of Claim 1, wherein the user interface is displayed at a display device coupled to the set-top box device.

5. The method of claim 1, further comprising transmitting the user interface to a web browser at a computing device via the public data network.

6. The method of claim 1, further comprising communicating television programming to the set-top box device with the user interface.

7. The method of claim 4, wherein the television programming is displayed at the set-top box device along with the user interface.

8. The method of claim 7, wherein the user interface overlays at least a portion of a displayed of the television programming.

9. The method of claim 7, wherein the user interface at least partially frames the television programming.

10. The method of claim 1, wherein the type of content is: weather content, sports content, financial content, traffic content, e-mail content, chat room content, news content, entertainment content, Internet search engine content, science content, health content, travel content, music content, radio content, game content, photograph content, video content, address content, phone number content, calendar content, appointment content, and map content.

11. The method of claim 8, wherein the traffic content comprises video of traffic associated with at least one user-selected route received at the user account via the public data network.

12. The method of claim 8, wherein the photographic content includes at least one photograph received at the user account via the public data network.

13. The method of claim 12, wherein the at least one photograph is incorporated into a slide transmitted to the set-top box device via the private network within the IPTV system.

14. The method of claim 1, further comprising:
receiving a content selection from the set-top box device via the private network within the IPTV system, wherein the content selection indicates a portion of content to be displayed at the display device;
retrieving the portion of content via the public data network; and
providing the portion of content to the set-top box device via the private network within the IPTV system.

15. A method of receiving web-based content, the method comprising:
receiving a user interface at a set-top box device via a private network within an IPTV system, wherein the user interface includes at least one type of content available via a public network;
wherein the set-top box device is associated with a public network user account at a server within the IPTV system; and
wherein the at least one type of content is associated with a user preference received at the public network user account.

16. The method of claim 15, further comprising transmitting the user interface to a display device.

17. The method of claim 16, wherein the user interface is transmitted in conjunction with television programming to the display device.

18. The method of claim 15, further comprising:
receiving a slide show via the private network within the IPTV system, wherein the slide show includes at least one photograph received at the public network user account; and
transmitting the slide show to the display device.

19. The method of claim 18, wherein the slide show is transmitted to the display device via an auxiliary channel of the display device.

20. The method of claim 18, wherein the slide show is incorporated into the user interface.

21. The method of claim 15, further comprising:
receiving a content selection at the set-top box device via the user interface, wherein the content selection indicates a portion of content to be displayed at a display device;
communicating the content selection to a server via the private network within the IPTV system;
receiving the portion of content at the set-top box device; and
transmitting the portion of content to the display device.

22. A system to receive web-based content, the system comprising:
a set-top box device comprising a processor and a memory accessible to the processor; and
a computer program embedded within the memory and executable by the processor, the computer program comprising instructions to receive a user interface at the set-top box device via a private network within an IPTV system, wherein the user interface includes at least one type of content available via a public network;
wherein the set-top box device is associated with a public network user account at a server within the IPTV system; and
wherein the at least one type of content is associated with a user preference received at the public network user account.

23. The system of claim 22, wherein the computer program further comprises:
instructions to receive data associated with the user interface at the set-top box device;
instructions to modify the user interface based at least partially on the data; and
instructions to transmit the modified user interface to a display device.

24. A system to receive web-based content, the system comprising:
a server within a private data network of an Internet Protocol Television (IPTV) system, wherein the server includes a processor and a memory accessible to the processor; and
a computer program embedded within the memory and executable by the processor, the computer program comprising:
instructions to receive data via a user account of a public data network, wherein the data includes a type of content available via the public data network;
instructions to associate the user account with a user interface that is selectively communicated to a set-top box device via the private data network;
instructions to modify the user interface to include the type of content, based at least partially on the data; and
instructions to transmit the modified user interface to the set-top box device via the private data network.

25. The system of claim 24, wherein the computer program further comprises instructions to retrieve the user interface associated with the user account, by querying an information store with the user account.
